(19) United States
(12) Patent Application Publication
(10) Pub. No.: US 2002/0029250 A1
(43) Pub. Date: Mar. 7, 2002

(54) Method and apparatus for transmitting an electronic message on electronic letterhead

(76) Inventor: Jay Reiner, N. Miami, FL (US)

Correspondence Address: Steven M. Greenburg, Akerman Senterfitt, 222 Lakeview Avenue, Fourth Floor, P.O. Box 3188, West Palm Beach, FL, 33402-3188, US

(21) Appl. No.: 09/924,827

(22) Filed: Aug. 8, 2001

Related U.S. Application Data
(60) Provisional application No. 60/223,954, filed on Aug. 9, 2000.

(51) Int. Cl. G06F 15/16

(52) U.S. Cl. 709/206

(57) ABSTRACT

The present invention is a method and apparatus for distributing computer-enhanced artwork for use in electronic messaging. Specifically, the present invention can create and distribute electronic stationery incorporating a computer-enhanced logo. First, a customer can register to access the host artwork distribution system. Following registration, the customer can provide a logo or other artwork to the host system. The logo can be combined with a marketing logo. Preferably the marketing logo is a graphically anchored hyperlink to the host artwork distribution system. The combined logo can be resized and optimized for transmission in a data communications network. Subsequently, the combined logo can be embedded into e-mail stationery. The e-mail stationery then can be distributed to the customer whose e-mail client can be automatically configured to cause the e-mail stationery to be combined with subsequent electronic messages.

### CROSS-REFERENCE TO RELATED APPLICATIONS

This patent application claims the priority of U.S. Provisional Patent Application No. 60/233,954 filed Aug. 9, 2000.

### BACKGROUND OF THE INVENTION

1. Technical Field

The present invention relates to the field distributing computer-generated electronic artwork. More particularly, the present invention is a method and apparatus for transmitting an electronic message on electronic letterhead.

2. Description of the Related Art

With the advent of the Internet and the corresponding boom in electronic communications, electronic business communications, particularly electronic mail (“e-mail”), have surpassed the traditional letter as the primary method for performing business communications. Still, the vast majority of electronic business communications, particularly e-mail, is bland, un-branded, unprofessional and not differentiated. Unlike traditional non-electronic business communications, for example letterhead, business cards and the like, electronic business communications have not evolved to an equivalent level.

There are several reasons that electronic business communications have not achieved the same professional appeal as the more traditional letter written on business letterhead. First, business logo artwork which primarily is created for paper print applications, does not transfer well to electronic media, for instance e-mail. Specifically, when traditional business logo artwork is digitized “as is” the resulting electronic files can become far too large to be used efficiently in electronic communications. Additionally, presently there exists over one-hundred graphic file formats which can be used to electronically represent artwork; however, only a few are suitable for use in electronic communications. Thus, artwork files having various graphic file formats must be transformed into a graphic file format appropriate for efficient electronic communications. In particular, the graphic file format should produce an image optimized for efficient and quick electronic transfer and storage. Accordingly, there is a need to provide a more efficient means for distributing computer-enhanced artwork for use in electronic communications.

At least one company has attempted to combine computer-enhanced artwork with electronic communications. Specifically, Mailround, an e-mail marketing and branding company based in London, England, has developed a system which appends graphic advertisements and contest pieces in e-mails transmitted by subscribing users. In particular, the AudienceMail™ application “enhances regular e-mails by inserting an ‘interactive window’ along side the sender's original message, enabling the delivery of real-time content within the e-mail.” Press Release, Mailround Harnesses the Potential of E-mail for Corporate Users, (Mailround Apr. 27, 2001). Previous, Mailround applications provided for the automatic insertion of advertising banners in e-mail. Christopher Saunders, Real Media in Deal with Mailround, InternetNews—Advertising Report (Nov. 17, 2000).

Importantly, both Mailround applications fail to resolve the problems inherent in electronic business communications. That is, despite Mailround's efforts, business communications continue to the lack the visual appeal of conventional letterhead. For example, in the Mailround application of November 2000, only banner advertisements are included in an e-mail. Banner advertisements, however, are not a suitable substitute for professional letterhead. Similarly, the AudienceMail™ application places artwork in a separate window. Electronically distributable business letterhead, by comparison, should include business artwork as part of an e-mail and not in a separate window. Accordingly, there remains a need to provide a more efficient means for distributing computer-enhanced artwork for use in electronic communications.

### SUMMARY OF THE INVENTION

The present invention is a process for transforming artwork, for example a logo, into a computer-readable artwork which can be computer-enhanced, optimized and distributed to a client computer. The present invention automatically can create and install in a server computer an electronic letterhead which can contain the computer-readable artwork. Subscribing client computers can be configured so that when an e-mail is transmitted, the e-mail can be re-directed to the server computer in which the message in the e-mail and the computer-readable artwork can be combined. Subsequently, the e-mail can be forwarded to an intended recipient.

Alternatively, client-side software can be installed in a subscribing client computer. The client-side software can include logic for combining the artwork with an e-mail message. The artwork can be stored locally in the client, or remotely in a server. In either case, either during composition or when sending an e-mail, the artwork can be retrieved from storage and combined with the e-mail. Importantly, the manner in which the e-mail and artwork are combined are not intended to be limited by any particular implementation. Rather any suitable combining method can suffice, for instance the e-mail message text can be inserted into pre-configured letterhead, or the artwork can be inserted as a graphic image in the e-mail.

In operation, a customer can register with a host computer in order to access the artwork distribution system of the present invention. Following registration, the customer can provide a logo to the host system. The logo can be provided using any suitable means, ranging from electronic file transfer means to mail services offered by the U.S. Postal Service. Upon receipt, the host system can convert the logo to a suitable graphic file format and can combine the converted logo with an additional logo (for example a third-party or provider advertiser logo) to form a composite logo. Subsequently, the composite logo can be resized and optimized. The resized logo can be embedded into stationery suitable for use with an e-mail client, for example Eudora®) from Qualcomm Incorporated of San Diego, Calif., and Outlook® and Outlook Express® from Microsoft Corporation of Redmond, Wash.

In one aspect of the invention, the e-mail stationery containing the composite logo can be stored in an application server communicatively linked to subscribing e-mail clients via the Internet. Each e-mail client can be configured to communicate with the application server each time a user requests to compose and transmit e-mail to a recipient. Specifically, the mail server parameter of the e-mail client can be modified to specify the application server. In consequence, when a subscriber attempts to transmit an e-mail, the e-mail can be forwarded to the application server rather than the subscriber's default mail server. The application server, in turn, can combine the message text of the transmitted e-mail with the e-mail stationery before forwarding the e-mail to the intended recipient. In this way, each time the user creates a new e-mail in the e-mail client, the extracted e-mail stationery containing the computer-enhanced artwork can be used.

In another aspect of the invention, the e-mail stationery containing the composite logo can be compressed into a file suitable for electronic transmission from the host to the client computer. The compression can be performed using well-known compression techniques, for example PKZip or LHArc. Additionally, an installation program, for example a compiled object, executable or interpretable script, can be included in the compressed file. Notably, the compressed file can include a self-extracting mechanism as is well-known in the art. Subsequently, the self-extracting compressed file can be distributed to the client computer using any suitable file transfer technique, for example HTTP file transfer methods, FTP file transfer methods or e-mail attachments.

Upon receipt of the self-extracting compressed file, the user can extract the e-mail stationery and the installation program into a file directory. Subsequently, the user can execute the installation script. Preferably, the installation program can substitute the extracted e-mail stationery for the existing stationery used in the e-mail client of the client computer. The installation program preferably is an interpretable script which can perform the installation using emulated keyboard strokes which otherwise could be manually provided by the user to manually substitute the e-mail stationery for the existing stationery. Alternatively, the installation script can perform the installation using the published API for the e-mail client. Finally, the substitution of the e-mail stationery can be performed as part of the functionality of a plug-in which can be operatively linked to the e-mail client by the installation program.

In any case, each time the user creates a new e-mail in the e-mail client, the extracted e-mail stationery containing the computer-enhanced artwork can be used. Hence, the present invention is an automated process that utilizes a client's current logo or other artwork, for automatically creating and then installing an electronic letterhead for the client that can be used by the client in electronic correspondence such as e-mail.

A method of transmitting an electronic message on electronic letterhead can include generating electronic letterhead from computer-generated artwork; receiving a request to transmit an electronic message from a subscriber to a recipient, the subscriber and recipient each having an associated network addressable electronic message client; combining the electronic letterhead and the electronic message to form a composite electronic message; and, forwarding the composite electronic message to the recipient.

The method further can include configuring the subscriber's network addressable electronic message client to transmit electronic messages to an application server; receiving in the application server the electronic message from the subscriber's associated network addressable electronic message client; and, performing the combining and forwarding steps in the application server. Alternatively, the method further can include configuring the subscriber's network addressable electronic message client to perform the combining and forwarding steps. Notably, the configuring step can include installing a plug-in to the subscriber's network addressable electronic message client, the plug in performing the combining and forwarding steps. Alternatively, the configuring step can include substituting default stationery in the subscriber's network addressable electronic message client with the electronic letterhead.

The method further can include associating a hyperlink with the electronic letterhead, the hyperlink comprising a network address at which marketing information can be accessed by activating the hyperlink. The method further can include providing access over a computer communications network to the electronic letterhead; accepting user-modifications to the electronic letterhead; and, substituting the user-modified electronic letterhead for the generated electronic letterhead. The method further can include registering the subscriber, the registration including collecting demographic data for the subscriber.

A system for transmitting an electronic message on electronic letterhead can include electronic letterhead stored in a database, the electronic letterhead including computer-generated artwork; a composite message processor for combining received electronic messages with the electronic letterhead; a configuration applet for configuring an electronic message client to redirect transmitted electronic messages to the composite message processor; and, a message forwarding server configured to forward the composite messages to an electronic message server.

### BRIEF DESCRIPTION OF THE DRAWINGS

There are presently shown in the drawings embodiments of which are presently preferred, it being understood, however, that the invention is not so limited to the precise arrangements and instrumentalities shown, wherein:

FIG. 1 is an exemplary network architecture diagram illustrating the flow of information between the various network entities with respect to the various steps in accordance with the invention;

FIG. 2 is a schematic illustration of a system configured to combine an electronic message with electronic letterhead prior to forwarding the composite message on letterhead to a designated recipient; and,

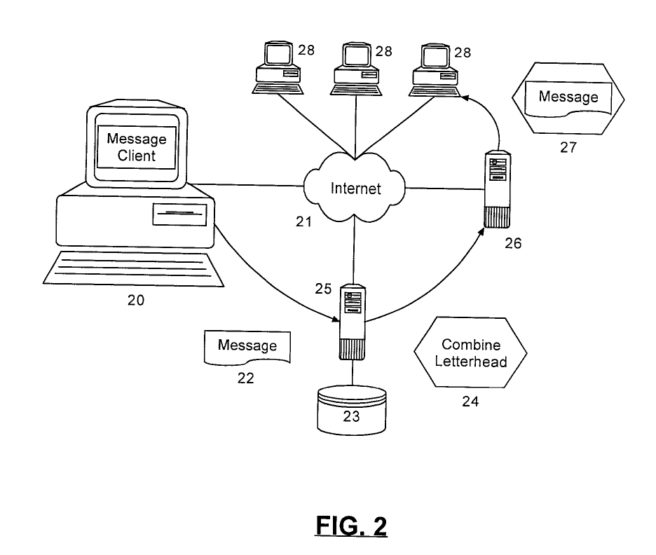

FIG. 3 is a block diagram illustrating an exemplary client-server architecture in accordance with the invention.

### DETAILED DESCRIPTION OF THE INVENTION

The present invention is a method and apparatus for distributing computer-enhanced artwork for use in electronic messaging. Using the inventive method an electronic message can be transmitted on electronic letterhead. More particularly, in the preferred embodiment, the present invention can distribute electronic stationery incorporating computer-enhanced artwork wherein the electronic stationery can be installed either in an e-mail client or application server. In consequence of the present invention, electronic communications created by the e-mail client can be combined with the electronic stationery in the same manner as would be the case with traditional business letterhead. Thus, resulting e-mails created using the stationery of the present invention, like traditional business letterhead incorporating traditional business artwork, are lively, branded, professional and differentiated.

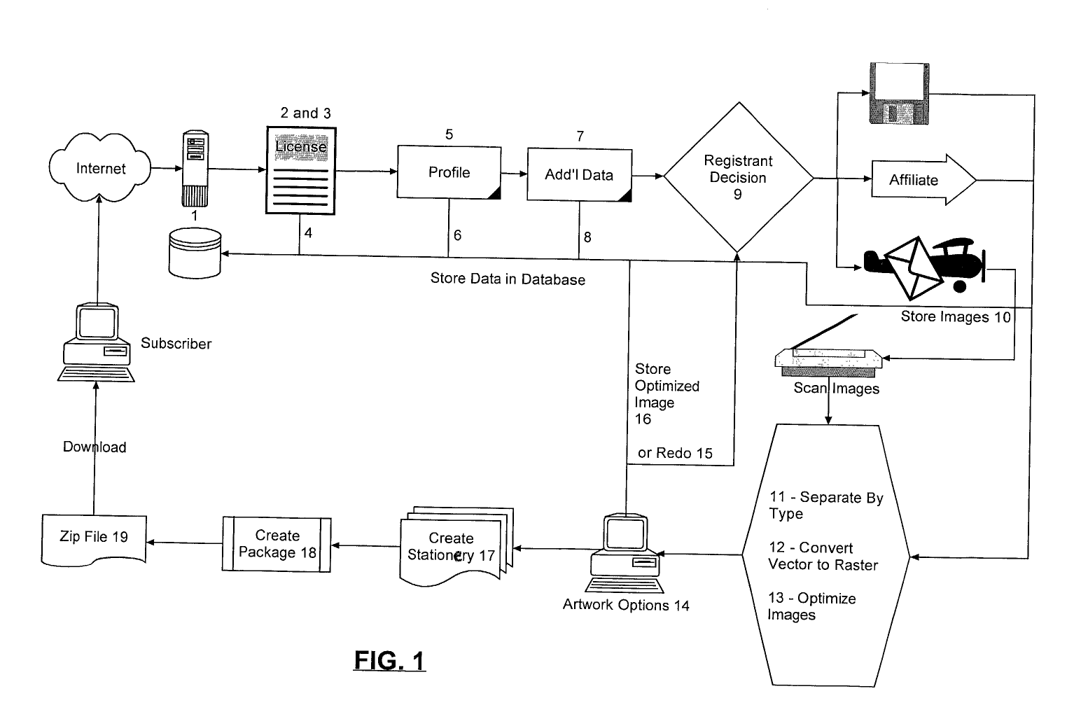

Turning now to FIG. 1, a method for distributing computer-enhanced artwork for use in electronic messaging shall be illustrated. As shown in FIG. 1, in step 1, initially a subscriber can electronically connect to a host artwork distribution system in which a method of distributing computer-enhanced artwork can reside in the form of a series of network distributable documents (“Web pages”), computer programs, manually or automatically operable functions and scripts.

The electronic connection can occur by means of the World Wide Web (“Web”) although the invention is not limited in regard to the particular method of establishing communications between the client computer and the host artwork distribution system. In particular, the electronic connection can occur by any means suitable for communications between one or more computing devices or processes in a data communications network, for example a Bulletin Board System (“BBS”) or the File Transfer Protocol (“FTP”). Notably, the client computer can be any suitable computing device through which the Web can be accessed, for example a laptop computer, Web-enabled embedded computing device, personal digital assistant (PDA), Web-enabled cellular telephone, etc. Still, in the preferred embodiment of the present invention, the subscriber can connect to the host system through the Web using a Web browser in a personal computer and a suitable corresponding hypertext transfer protocol (“HTTP”) request, for example, “http://www.artworkdistributionsystem.com”. In response, the user can view the home page of the host system for use in accordance with the inventive arrangements.

The home page can contain information including links to frequently asked questions (FAQ), contact information and other pertinent content. From the home page, the registrant can navigate and view additional Web pages relating to the artwork distribution system of the present invention. In one embodiment of the invention, the artwork distribution system can be implemented using active server pages (ASP) scripts and hypertext markup language (HTML) based Web pages. In addition, the Web pages of the host system can be distributed using a Web server, for example Internet Information Server® (IIS) available from Microsoft Corporation of Redmond, Wash. Still, it should be readily understood by one skilled in the art that the exemplary implementation is not intended to be a limitation of the invention. For example, alternate Web servers can be employed, for example, an Apache Web server or an iPlanet® Web Server available from the Sun-Netscape Alliance of Palo Alto, Calif.

In steps 2 and 3, upon receiving a request for the home page of the host system, the Web server preferably causes to be displayed on the subscriber's display screen, a copy of a license agreement outlining the terms and conditions of use of the Web site. The license terms can govern the acceptable use of the branded trademark's e-mail, in addition to legal disclaimers concerning the registrant/licensee supplied information. A subscriber, whether existing or new, preferably must agree to the displayed terms and conditions before access is granted to the Web site. Preferably, information pertaining to privacy and confidentiality policy of the Web site also can be displayed. The license agreement can be implemented as a HTML form, wherein the registrant can make an active selection in order to proceed. In one aspect of the invention, the subscriber's assent to the terms and conditions of the license agreement can be stored in fixed storage.

If this is the first time that the user accesses the host system, then the Web server causes to be displayed a registration screen for new registrants. The new registrants can enter identifying information and other pertinent information necessary to authenticate a registrant. In step 5, a login profile can be created by supplying an e-mail address along with a password. Following registration, the Web server causes to be displayed, certain login and validation screens. In response, in step 6 the registrant's information is stored in a database for future reference and authentication.

The login and registration process of step 5 may be implemented on the Web server. Preferably, data accumulated during the login and registration process is stored in a relational database, for example a relational database managed by SQL Server 7.0®) manufactured by Microsoft Corporation of Redmond, Wash. It should be understood by one skilled in the art that other implementations are possible. For example, client entries could be validated using a Java script, Perl script or VBScript. Other database engines such as those available from Oracle Corporation of Redwood Shores, Calif., or Sybase Inc. of Emeryville, Calif. also could be used in lieu or complementary to SQL Server 7.0. Additionally, a variable storage mechanism, for example the extensible markup language (XML) or a text file, could also be employed.

In step 7, during registration subscribers preferably are required to provide additional demographic information. Specifically, the Web server can cause to be displayed on the subscriber's screen, certain questions pertaining to personal taste and preferences. The Web server can request that the subscriber provide input in response to the questions which can be stored in a database in step 8 as a personal profile for the subscriber. In particular, during the registration process, the subscriber can supply contact information and information about associated affiliations and/or organizations. If the subscriber is referred to the site from someone else within his/her organization, he/she does not need to fill out the company information. Instead, preferably, he/she is redirected to an abbreviated registration and subsequently to the download page to download the already created logo package.

Secondary subscribers can be verified by the primary subscriber (who is the default administrator) via a priority code that can be received via the primary administrator. Preferably, in steps 6 and 8 the registration data can be stored to the DB server using stored procedures. Alternately, data could be stored using dynamically generated SQL or data access COM objects such as Active Data Objects™ (ADO) record sets. After the initial registration session, subsequent sessions can require only a login ID and password and/or a specified priority code for access. Information pertaining to the subscriber's profile can be validated by the server and then stored in a relational database server. Entries from the subscriber can alternately be validated, for example using a Javascript. In accordance with the invention, the subscriber can have the option to add an additional slogan or other information to be used in an e-mail header or signature. This additional information can be stored to an enterprise level database server (SQL Server 7.0, for example). This data can be stored in other database servers as text files.

In step 9, once the initial access procedures are complete, the subscriber can supply the necessary artwork. In accordance with the invention, alternative embodiments exist for supplying the required artwork. In a first embodiment, where the artwork file is located on the subscriber's terminal, the subscriber can upload the artwork by locating the file with using a file open dialog box and actuating a transfer of the located file to the Web site. The artwork can be uploaded by employing Web-based file upload methods, for example as document in the request for comment, RFC1867 “Multi-form/posting Method Through an HTTP Connection.” An exemplary implementation of RFC1867 is the Microsoft Posting Acceptor (MPA).

In an alternate embodiment, the subscriber can send the artwork via a shipping method including regular mail or an expedited service. In accordance with this aspect of the invention, the server causes the Subscriber to be presented with a form that can contain all necessary information, for example, Customer #, Address, etc., already completed. The subscriber can print out the form and send the form along with the artwork in hard copy format. Upon receipt, the artwork, where in hard copy form, can be scanned into a suitable electronic format. Subsequently, the artwork can be added to the system. Once the artwork has been processed, the subscriber can be informed via e-mail.

In an alternate embodiment, the subscriber is given the option of creating a logo. The server causes to be displayed on the screen, a link to create an online logo/artwork. Alternately, the subscriber may contract for affiliate logo creation services. The subscriber can be linked to an affiliate site where the logo can be created either immediately by the subscriber or within a few business days by the creative service affiliate. The subscriber then can upload the created logo file following the upload steps previously outlined. Regardless of the method of obtaining the artwork, however, in step 10 the received electronic file containing the artwork can be stored in fixed storage in its original format, preferably as a re-sizeable vector. Image files can be stored in a data-store consisting of separate file directories for each company. In an alternate embodiment, images could be stored as binary data in the DB server.

In accordance with the invention, in step 11 files can be separated by type (raster/vector). In step 12, if the file is a vector file, the vector image can be converted to a raster image. In step 13, the raster images are resized and four different levels of optimized images are generated. Specifically, a Component Object Model (COM) automation server is created that in turn controls an image manipulation tool, for example, Photoshop 5.5® manufactured by Adobe Systems Incorporated of San Jose, Calif. In the image manipulation tool, each file can be opened and an anti-aliasing filter applied. The filter is used to prevent a jagged look. The file is then flattened wherein all of the image layers are merged. Finally the file is stored as a high quality bitmap, preferably with 24-bit color depth and no compression. This can ensure the best possible image source for subsequent optimization. Alternatively, other image processing tools can be used, for example the GNU Image Manipulation Program (GIMP).

Importantly, a hyperlink to the Web site can be attached to the image and the image can be returned to the subscriber for review. In one embodiment of the invention, the file can be processed and optimized for Web/e-mail use by reducing the image size and actual file size. A plurality of alternative images formats using alternate compression and dimension variables can be generated using an image processing component, for example. The files can then be stored in Joint Photographic Experts Group (JPEG) and/or Graphics Interchange Format (GIF) format. Preferably, the artwork file size should not exceed 10 Kb although the invention is not limited in this regard.

In an alternative embodiment, a second COM automation server can be created to control an image processing component for manipulating electronic images and storing electronic images in a variety of graphics file formats. The high quality source file can then be opened. Preferably, a second image containing marketing material is opened. The second image can include a slogan, for example “Powered by XYZ”. In accordance with a further aspect of the invention, the images are then merged as JPEG files, in preferably, two different dimensions, preferably not to exceed 100×250 pixels and 80×250 pixels, so as to maintain the aspect ratio of the images. Additionally, the same files also can be saved as uncompressed GIF files in the same sizes. Still, the GIF files can be considerably larger than the JPEG files.

A JPEG file is a compressed image file format supported by most major Internet tools (browsers, e-mail clients). A JPEG file is considerable smaller than a bitmap due to the compression algorithm that is used. When a JPEG file is saved, the compression level can be specified. The greater the level of compression used, the lower the image quality, however, the file size is accordingly lowered. A GIF file is also a compressed file format supported by most Internet tools. A GIF file uses a different compression algorithm (LZW) that reduces the number of colors that are used in the image. This makes the format more suitable for non-photographic images or images that require less detail to illustrate a subject.

In accordance with the invention, an image formatting and optimization tool can be automatically used on the aforementioned images to shrink the same to a size that is typically smaller than a JPEG version those same images. The files containing the images are compressed using the LZW algorithm. It should readily be understood by one skilled in the art that alternative formats can be generated. Other image formats such as Portable Network Graphics (PNG) or Bitmap (BMP) could be generated. Different image manipulation tools, for example GIMP, can be used without departing from the spirit of the invention. Consistent with the invention, fewer or more alternative images could be created. Alternately, the step that merges the two images could be skipped.

In step 14, in a further aspect of the invention, artwork is displayed on the screen and the subscriber can have the option to choose the most suitable image. The subscriber can choose the most suitable image from the possible alternatives being displayed. The server causes to be displayed on the subscriber's display, four (4) images. The subscriber can select the best image based on image quality, image size requirements and file size. In one aspect of the invention a preview page can be dynamically built that references the four alternative images. The subscriber can have the option to select any of the displayed images. Preferably, GIF images are more suitable for Line Art/Type Graphics whereas JPEG files are more suitable for highly detailed photos. In an alternate embodiment, the images could be e-mailed to the subscriber for selection so that the subscriber can make a determination of which image to use. Alternately, the system could make a default determination on which image to use.

If the artwork is not of an acceptable quality, in step 15 the process of acquiring a suitable artwork can be repeated. The process of repeating the acquisition can be presented to the registrant in the form of a choice. In a further aspect of the invention, each image could be analyzed based on file size, dimensions and level of image detail. Once the image is chosen, in step 16 the Web-optimized image can be stored. Preferably, the image is stored in a directory structure located within the database. This ensures easy access to the files, especially for future use. Alternatively, images are discarded or archived on magnetic media.

In accordance with a further aspect of the invention, in step 17 a HTML e-mail stationery can be dynamically created. The stationery file can consist of image references and hyperlinks to the subscriber and marketing links to other Web sites. Once the HTML file has been created the file can be accessed and previewed online. A custom made COM component can be created to open a HTML template stationery file. The file can contain placeholders for data that is dynamic, for example image references, URLs, and Slogans. The dynamic data can then be read from the company database and used to replace the placeholders. The new HTML template can be stored within the company data-store. In an alternate embodiment, each outgoing e-mail can be processed either by an add-in installed on the mail client or by an e-mail server.

In a further aspect of the invention, as illustrated in step 18, the images and the stationery can be packaged. The package can be created as a self-extractable compressed zip file shown in step 19 that can be made available for download. This can consists of a *.CMD file that is executed on the web server that in turn executes an archive/extraction program, for example WinZip 8.0 and WinZip Self Extractor® both from WinZip Computing, Inc. of Mansfield, Conn., to perform the following steps dynamically as a user navigates the Web site:

1. Create a *.zip file, for example through a command line provided command or automatically through an API function call.

2. Include in the *.zip file a previously compiled installation and configuration script in executable form, for example an Autolt™ script. Automation programs such as Autolt provides for automated software installations and other tasks through the use of scripts. The script file can be used to perform window commands (waiting for, hiding, activating, and so on) in addition to transmitting keystroke messages to specific windows. Notably, any automation method capable of performing automated tasks can suffice for accomplishing the installation and configuration of the e-mail stationery.

3. Include in the *.zip file specific graphics for the user based upon the uploaded and converted artwork initially supplied by the user.

4. Convert the *.zip file to a self-extracting executable (preferably via command line although API calls are available for automated functionality).

5. Configure the self-extracting executable to execute the script by selecting an “execute after” option.

When the self-extracting *.exe file opens, all files can be decompressed or “unzipped” to a specified directory for the e-mail client in which the e-mail stationery can be accessed. Subsequently, in accordance with the execute after option, the script can execute in consequence of which the e-mail stationery can be installed and the e-mail client can be configured to use the e-mail stationery when creating e-mails. In the preferred embodiment, the WinZip compression tool and the Autolt scripting tool can be used to implement the above-described procedure. Nevertheless, it should be readily understood by one skilled in the art that the selection of the WinZip and Autolt tools are not limitations of the instant invention. Other compression, scripting or, alternatively, installation and packaging programs can be used in lieu of the preferred compression and scripting tools. In fact, if necessary, the e-mail stationery and the installation script can be downloaded automatically or manually on an individual basis.

In yet a further aspect of the invention, the subscriber can download and extract the executable file from the Web server. The package can contain folder information that will be compatible with the setup of most registrant/licensees' computers. However the subscriber can have the option to override these settings and install and execute the package anywhere on the subscriber's hard-drive. With regard to the self-extracting files, the files are automatically extracted when the program is executed. In a further aspect of the invention, the registrant/licensee can execute and install the files. This is illustrated in step 19. The install can be performed by emulating keystrokes, such as by using the Autolt scripting tool. Autolt scripts are designed to allow configuration of software applications where settings are not easily changed via the registry or by other means. The tool provides a convert-to-EXE option that allows a user to compile previously created scripts.

In one embodiment of the invention, two Autolt scripts are created and executed. The first script is designed for Outlook, the second for Outlook Express. Other similar scripts can be created for other e-mail clients, for example Eudora. The scripts can manually configure the specific e-mail client for HTML e-mail and stationery setup if the client supports stationery. The manual configuration can be performed by emulating keystrokes. In the Outlook implementation, files are extracted to a default common file area that is used to setup stationery. Alternatively, a desktop application can perform the necessary registry changes and file copying that is required, instead of emulating keystrokes.

In a further embodiment of the invention, the subscriber can forward references to the artwork distribution system to other network-connected users. In particular, the user can be prompted to provide e-mail addresses for the intended recipients. For recipients within the same organization who would normally prefer to use the same stationery, a priority code can be issued that allows access to the same artwork supplied by the current registrant/licensee. For recipients in different organizations who would normally prefer to use different stationery, no priority codes are necessary.

In a further aspect of the invention, all e-mails created by a registered user which incorporate the artwork also, by virtue of the present invention, will transfer a marketing reference to the artwork distribution system to recipients of the e-mail. Hence, e-mail incorporating artwork distributed in the present invention will be discernable by anyone to whom an e-mail is sent. In consequence, recipients of the e-mail are encouraged to register for branded e-mail produced by the present invention. In a further embodiment of the invention, registrants/licensees can log into the Web site at any time. If the user wishes to update any information or re-generate their branded e-mail header, they can, at any time, return to the Web site. After logging in, all information can be updated and new artwork can be uploaded.

In yet another embodiment of the invention, instead of inserting logos or other artwork into electronic mail, similar processes could be used by someone skilled in the art, to reformat and insert other electronic templates for a variety of other uses within software programs. For example, word processing programs, fax programs, and/or accounting programs.

In a further aspect of the invention, multiple images can be stored and the client can select images from the stored list. For example, the subscriber can have the option of selecting from a plurality of images for each outgoing message. In a further aspect of the invention, similar image manipulation processes automatically format and insert other multi-media file types, for example, moving GIF, JPEG, MP3, QuickTime, MOV, WAV, VRML, 3d Web Interact, and Streaming Video. Furthermore, additional HTML or DHTML areas can be inserted into the e-mail or other electronic messaging systems that would contain additional functionality. This can include, combining multiple images with specific and different functionality into one image block within a user's e-mail message. The functionality can include, but is not limited to, coordinate-based connections to various other URLs, electronic and virtual signatures, encryption keys, virtual business cards, live cameras, voice recordings, and animations.

In an alternate embodiment of the invention, additional and completely separate HTML or DHTML areas can be inserted into the body of a client's electronic message. One functionality can include providing navigation and control mechanisms and functionality that is drawn from the client's web site through parsing and/or self-selection or a combination of the two. This can result in a personalized interaction tool, launch pad or task bot both connecting the client's website with the user and allowing electronic mail based transactions and transaction tracking. This can take the appearance of a toolbar or navigation bar.

In an alternate embodiment, additional HTML or DHTML area functionality can link to other services, for example a blind user survey that can be compiled anonymously by the host website, for the client's use. Alternately the additional HTML or DHTML areas could provide a mechanism for on-line, click-through contests or other promotional marketing. Alternatively, the additional HTML or DHTML areas can provide for intra-company and inter-company calendaring, messaging and collaborating. Moreover, the additional HTML and DHTML areas can provide a vehicle for on-line click-to-dial (links to automatic dialing) for telephony or other electronic connections.

In one aspect of the invention, in operation, a message client 20, such as a subscriber, can compose and send one or more electronic messages to a designated recipient 28 disposed about the Internet. While a typical message client would be configured to forward the composed messages to a mail server 26 which has been specially configured merely to forward electronic messages to designated recipient mail servers, in the present invention the message client 20 has been pre-configured instead to forward messages 22 to the logo server 25. Logo server 25 can include letterhead which has been generated according to the process illustrated in FIG. 1.

Upon receipt of the message 22, the logo server 25 can combine the message 22 with stored letterhead 24 to form a composite message 27. Subsequently, the logo server 25 can cross-reference the message client 20 with a pre-specified mail server 26. Once the mail server 26 has been identified, the logo server 25 can forward the composite message 27 to the mail server 26. The mail server 26, in turn, can forward the composite message to the designated recipient 28.

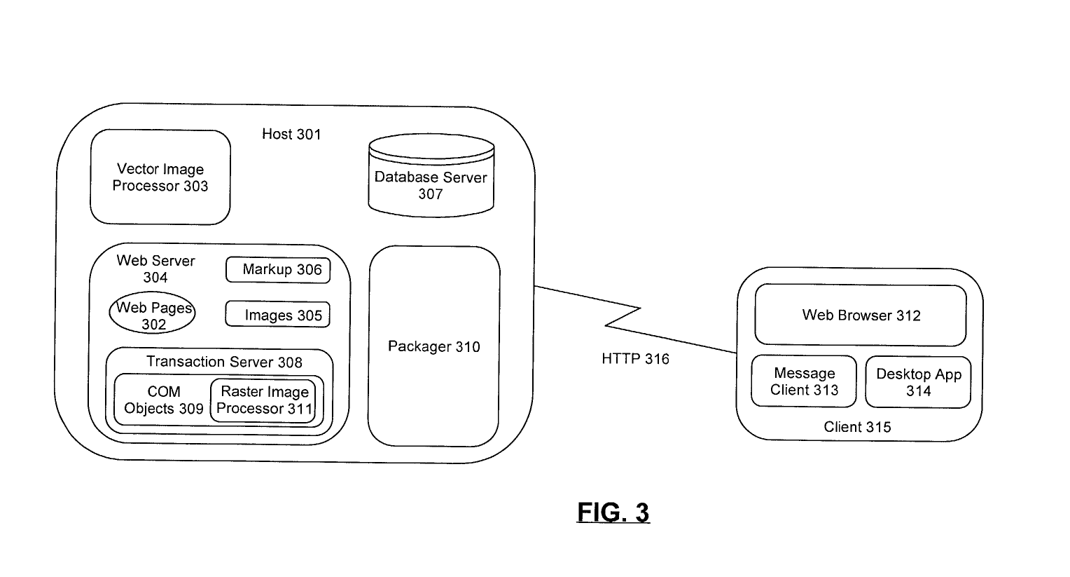

In accordance with the invention, an exemplary logo server is illustrated in FIG. 3. The server can include a host 301 and a client 315. Host 301 can include a vector image processor 303 which can be an application such as Photoshop 5.5, running on the server. Additionally, an archiving/extracting utility application, such as Winzip Packager 310, can also reside on the host. The host 301 can include Web server 304 in communication with a database server 307. Database server 307 provides open database connectivity to Web server 304. Web server 304 can act as a local store for Web pages 302 which include both markup 306 and images 305. Within the Web server 304, a transaction server, for example Microsoft Transaction Server® (MTS) 308 can host COM components 309 which are responsible for form management, raster image processing 311, database utilities, image processing automating (Photoshop/Image Glue) and functionality packaging. The client 315, by comparison, can include a Web browser 312 such as Netscape Communicator® or Internet Explorer®. A message client 313 can reside on the client 302 as can one or more desktop applications 314. The host 301 can communicate with the client computer 315 via HTTP connection 316.

The present invention can be realized in hardware, software, or a combination of hardware and software. A method and apparatus for transmitting an electronic message on electronic letterhead which has been configured in accordance with the present invention can be realized in a centralized fashion in one computer system, or in a distributed fashion where different elements are spread across several interconnected computer systems. Any kind of computer system, or other apparatus adapted for carrying out the methods described herein, is suited.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

I claim:

1. A method of transmitting an electronic message on electronic letterhead comprising the steps of:
generating electronic letterhead from computer-generated artwork;
receiving a request to transmit an electronic message from a subscriber to a recipient, said subscriber and recipient each having an associated network addressable electronic message client;
combining said electronic letterhead and said electronic message to form a composite electronic message; and,
forwarding said composite electronic message to said recipient.

2. The method of claim 1, further comprising the steps of:
configuring said subscriber's network addressable electronic message client to transmit electronic messages to an application server;
receiving in said application server said electronic message from said subscriber's associated network addressable electronic message client; and,
performing said combining and forwarding steps in said application server.

3. The method of claim 1, further comprising the step of:
receiving said computer-generated artwork from said subscriber.

4. The method of claim 1, further comprising the step of:
configuring said subscriber's network addressable electronic message client to perform said combining and forwarding steps.

5. The method of claim 4, wherein said configuring step comprises the steps of:
installing a plug-in to said subscriber's network addressable electronic message client, said plug in performing said combining and forwarding steps.

6. The method of claim 4, wherein said configuring step comprises the step of:
substituting default stationery in said subscriber's network addressable electronic message client with said electronic letterhead.

7. The method of claim 1, further comprising the step of:
associating a hyperlink with said electronic letterhead, said hyperlink comprising a network address at which marketing information can be accessed by activating said hyperlink.

8. The method of claim 1, further comprising the steps of:
providing access over a computer communications network to said electronic letterhead;
accepting user-modifications to said electronic letterhead; and,
substituting said user-modified electronic letterhead for said generated electronic letterhead.

9. The method of claim 1, further comprising the step of:
registering said subscriber, said registration comprising collecting demographic data for said subscriber.

10. A system for transmitting an electronic message on electronic letterhead comprising:
electronic letterhead stored in a database, said electronic letterhead comprising computer-generated artwork;
a composite message processor for combining received electronic messages with said electronic letterhead;
a configuration applet for configuring an electronic message client to redirect transmitted electronic messages to said composite message processor;
an message forwarding server configured to forward said composite messages to an electronic message server.

11. A machine readable storage having stored thereon a computer program for transmitting an electronic message on electronic letterhead, said computer program comprising a routine set of instructions for causing the machine to perform the steps of:
generating electronic letterhead from computer-generated artwork;
receiving a request to transmit an electronic message from a subscriber to a recipient, said subscriber and recipient each having an associated network addressable electronic message client;
combining said electronic letterhead and said electronic message to form a composite electronic message; and,
forwarding said composite electronic message to said recipient.

12. The machine readable storage of claim 11, further comprising the steps of:
configuring said subscriber's network addressable electronic message client to transmit electronic messages to an application server;
receiving in said application server said electronic message from said subscriber's associated network addressable electronic message client; and,
performing said combining and forwarding steps in said application server.

13. The machine readable storage of claim 11, further comprising the step of:
receiving said computer-generated artwork from said subscriber.

14. The machine readable storage of claim 11, further comprising the step of:
configuring said subscriber's network addressable electronic message client to perform said combining and forwarding steps.

15. The machine readable storage of claim 14, wherein said configuring step comprises the steps of:
installing a plug-in to said subscriber's network addressable electronic message client, said plug in performing said combining and forwarding steps.

16. The machine readable storage of claim 14, wherein said configuring step comprises the step of:
substituting default stationery in said subscriber's network addressable electronic message client with said electronic letterhead.

17. The machine readable storage of claim 11, further comprising the step of:
associating a hyperlink with said electronic letterhead, said hyperlink comprising a network address at which marketing information can be accessed by activating said hyperlink.

18. The machine readable storage of claim 11, further comprising the steps of:
providing access over a computer communications network to said electronic letterhead;
accepting user-modifications to said electronic letterhead; and,
substituting said user-modified electronic letterhead for said generated electronic letterhead.

19. The machine readable storage of claim 11, further comprising the step of:
registering said subscriber, said registration comprising collecting demographic data for said subscriber.
